(19) United States
(12) Patent Application Publication
(10) Pub. No.: US 2014/0097293 A1
(43) Pub. Date: Apr. 10, 2014

(54) Airplane Shock Absorbing Suspension

(71) Applicant: John Charles Roberts, Middleton, ID (US)

(72) Inventor: John Charles Roberts, Middleton, ID (US)

(21) Appl. No.: 13/649,086

(22) Filed: Oct. 10, 2012

(51) Int. Cl. B64C 25/02; F16F 13/06; F16F 1/36

(52) U.S. Cl. CPC B64C 25/02; F16F 1/36; F16F 13/06
USPC 244/100 R; 267/219; 267/153

(57) ABSTRACT

A landing gear strut incorporating an oleo-pneumatic shock absorber with a bungee return spring. An oleo-pneumatic shock absorber is a device engineered for slowing down a moving mass. The shock absorber converts the kinetic energy of the impact into heat due to the friction of oil being driven through narrow orifices. The shock then recovers using air and or spring pressure. The recovery is governed by the flow rate of the fluid to the original reservoir. In the case of an aircraft this results in less bounce, shorter stop time, smoother overall ride, and safer landings.

### FIELD OF INVENTION

This invention relates to suspension systems for small aircraft.

### DESCRIPTION OF PRIOR ART

Historically landing gear struts (FIG. 1, 100) used on light aircraft incorporating a cabane “v” have used bungee cords or rings (FIG. 1, 101) as the sole shock absorbing device. These struts are connected to the axle (FIG. 1, 102) of the landing gear and a cabane “v” (FIG. 1, 103) which is connected to the aircraft on either side of the fuselage (FIG. 1, 104) where the main leg of the landing gear (FIG. 1, 105) attaches. Bungees absorb and store kinetic energy upon landing or impact imparted by the expansion of the landing gear strut. The stored energy is released when the bungee contracts/recovers sometimes causing a spring or bounce effect. Other systems utilize compacted rubber discs (FIG. 2, 106) which work in much the same way as a bungee cord in that they absorb and store the kinetic energy imparted by the expansion of the landing gear strut and release that stored energy when they recover. However under the compression of a landing or impact these discs may not return/recover predictably or to a full static position.

### DESCRIPTION OF THE INVENTION

The invention incorporates an oleo-pneumatic shock absorber and a bungee return assist. The invention uses a dynamic axle strut to compress a shock absorber while stretching the bungee return. This process works by using a shock absorber attached to the dynamic axle strut in parallel. The shock is connected to the dynamic axle strut through a slot in the static strut which is attached to the cabane “v”, and at the bottom of the static strut. When a landing load is applied the shock strut is allowed to expand; the dynamic strut compresses the oleo-pneumatic shock absorber. The shock absorber dampens/absorbs the kinetic energy imparted from landing then predictably recovers/returns at an adjustable and controllable rate assisted by the bungee return. This adjustable return rate can be set directly using a hand air pump or cartridge or remotely during flight from the cockpit using a compressor.

### DESCRIPTION OF DRAWINGS

FIG. 1: This depicts a bungee shock strut suspension system on a small aircraft. The main landing gear, axle, cabane “v”, aircraft mounting points, and shock strut are included.

FIG. 2: This depicts a rubber disc compression suspension system on a small aircraft. The main landing gear, axle, cabane “v”, aircraft mounting points, and shock strut are included.

FIG. 3: Dynamic strut leg components

FIG. 4: Dynamic strut leg assembled

FIG. 5: Static strut leg

FIG. 6: Static strut leg assembled

FIG. 7: The dynamic shock mount and spring assist mechanism components

FIG. 8: The dynamic shock mount and spring assist mechanism assembled

FIG. 9: Dynamic strut leg and static strut leg assembled

FIG. 10: Dynamic strut leg, static strut leg, and dynamic shock mount and spring assist mechanism assembled

FIG. 11: Shock Absorber and Return Assist Spring

FIG. 12: Assembled shock strut with shock absorber and spring assist shown uncompressed

FIG. 13: Assembled shock strut with shock absorber and spring assist shown compressed

FIG. 14: Suspension strut side view “shock side”

FIG. 15: Suspension strut side view “bungee return assist side”

### DETAILED DESCRIPTION OF THE INVENTION

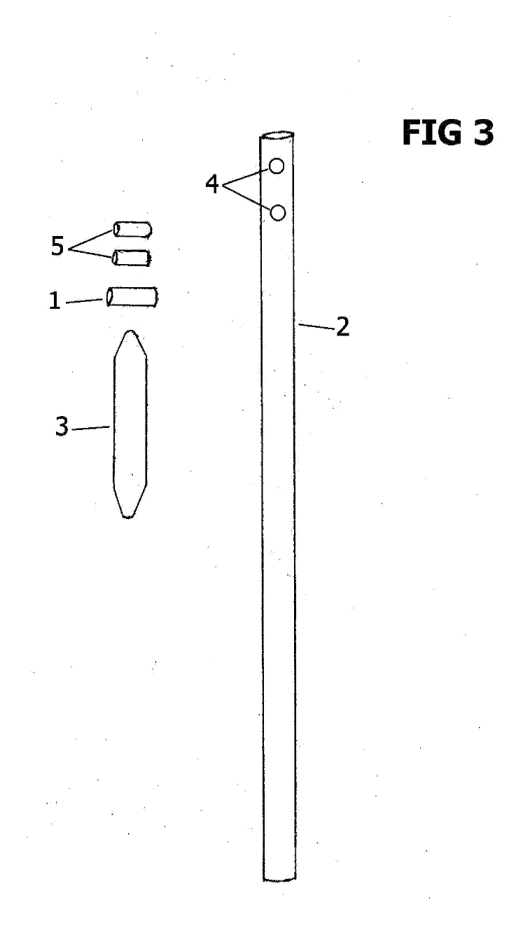

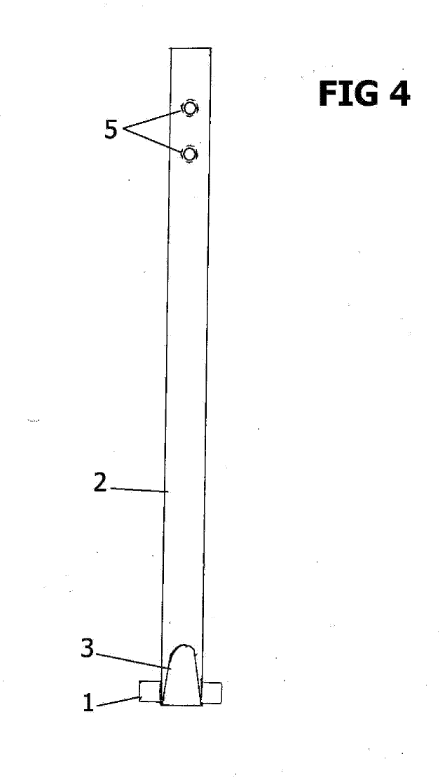

Referring to FIGS. 3 and 4 the dynamic strut leg is depicted fully assembled in FIG. 4 while a components view is depicted in FIG. 3. The axle connection bushing (1) is welded to the end of the dynamic strut leg tube (2) at one end. A reinforcing patch (3) is then welded over the bushing and to the dynamic strut leg tube. The other end of the dynamic strut leg tube is drilled at (4) and the dynamic shock mount bushings (5) are inserted and welded in place.

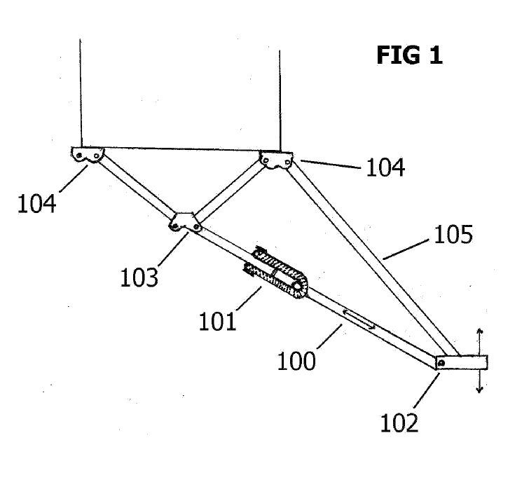

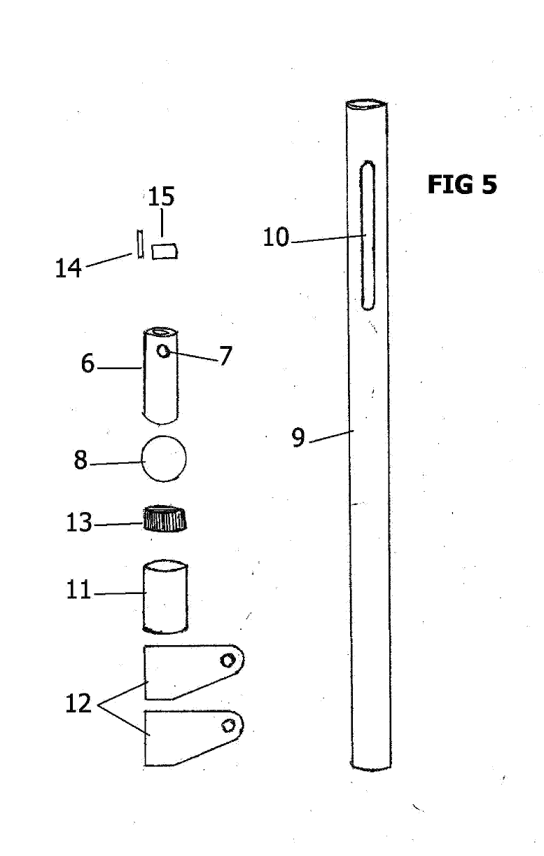

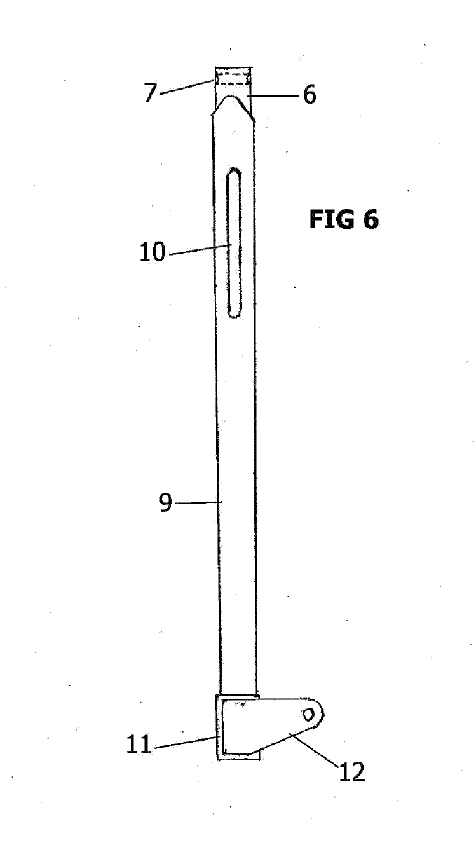

FIGS. 5 and 6 refer to the static strut leg. In FIG. 5 the static strut leg components are shown while the assembled strut is shown in FIG. 6. The cabane “v” attachment tube (6) is drilled at one end (7) to allow the static strut to bolt to the cabane “v” (FIG. 1, 103). A cap (8) is then welded on the other end to prevent moisture and debris from entering the strut assembly. At this point the cabane “v” attachment tube is inserted into one end of the static strut leg tube (9) and welded in place. The static strut leg tube is slotted (10) perpendicular to the orientation of the cabane “v” attachment hole. A reinforcement sleeve (11) is then welded on the end of the static strut leg tube opposite the cabane “v” attachment tube. The static shock mount brackets (12) are then aligned with the cabane “v” attachment holes and welded to the reinforcement sleeve. A rubber bumper (13) is inserted in the static strut leg tube and set flush to the cap on the cabane “v” attachment tube. A bungee hook consisting of a bungee retainer (14) and bungee hook tube (15) is welded to the static strut between the dynamic shock mount and spring assist and the cabane “v” attachment (24) to complete the strut base assembly.

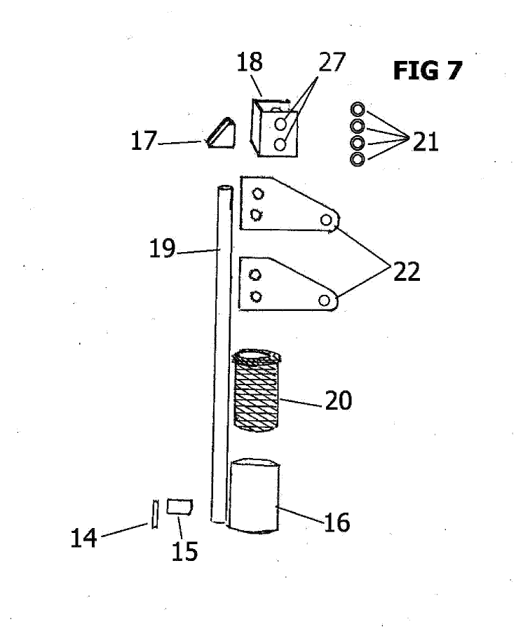

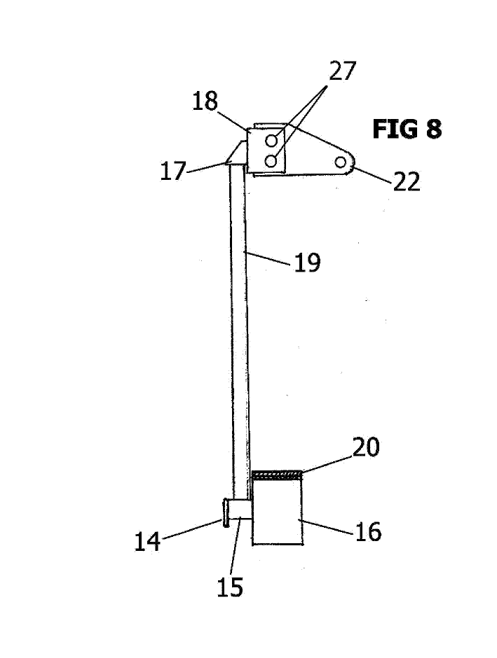

FIGS. 7 and 8 are of the dynamic shock mount and spring assist mechanism. Components of said system are shown in FIG. 7. The bungee hook retainer (14) is welded to the bungee hook tube (15). The bungee hook tube is then welded to the spring assist guide sleeve (16). The pushrod gusset (17) is welded to the dynamic bungee bracket (18). These two components are then connected by the pushrod (19); the pushrod is welded at one end to the spring assists guide sleeve and bungee hook while the other is welded to the pushrod gusset and dynamic bungee bracket.

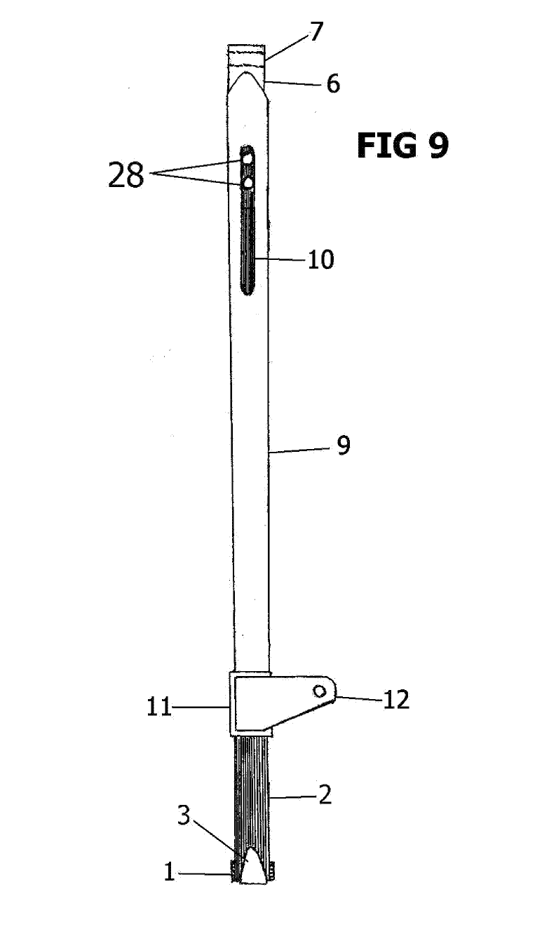

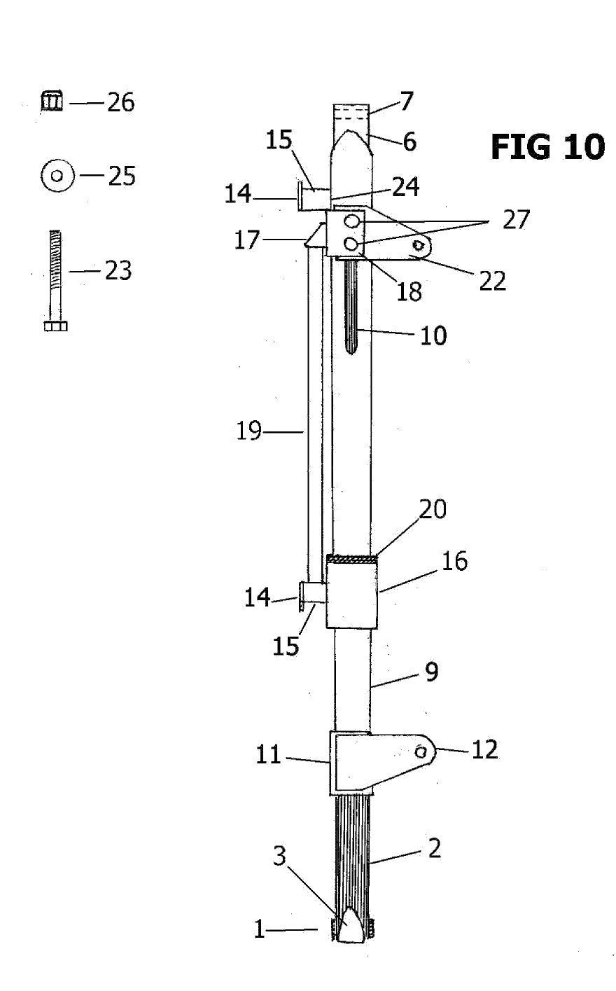

The following is referenced in FIGS. 7, 8, 9, and 10. At this point the 3 main components of the suspension strut are ready to be assembled. The dynamic strut leg tube is inserted into the static strut leg. The dynamic shock bushings are aligned with the dynamic shock mount slot (FIG. 9). The spring assist guide sleeve bushing (20) is slid over the static strut leg then the spring assist guide sleeve is fitted over the bushing. The dynamic shock mount spacers (21) are then placed at the dynamic strut legs bushings (28). The dynamic shock mounts (22) are set into place and the dynamic bungee bracket is set over both of those. Bolts (23), washers (25), and nuts (26) are then installed through the dynamic bungee mechanism bracket holes (27) and the dynamic strut leg (FIG. 10).

FIG. 9 shows the dynamic strut and static strut assembled. FIG. 10 shows the dynamic shock mount and bungee assist mounted to the strut assembly.

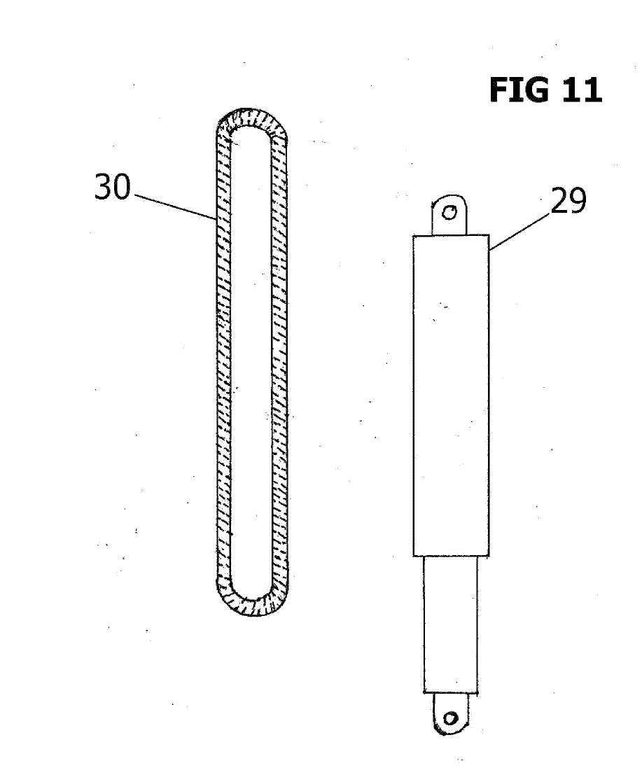

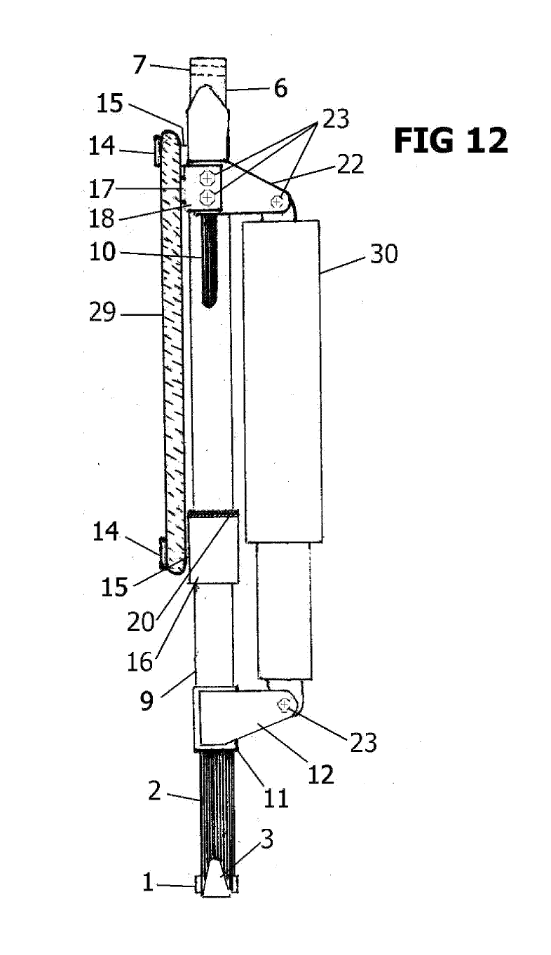

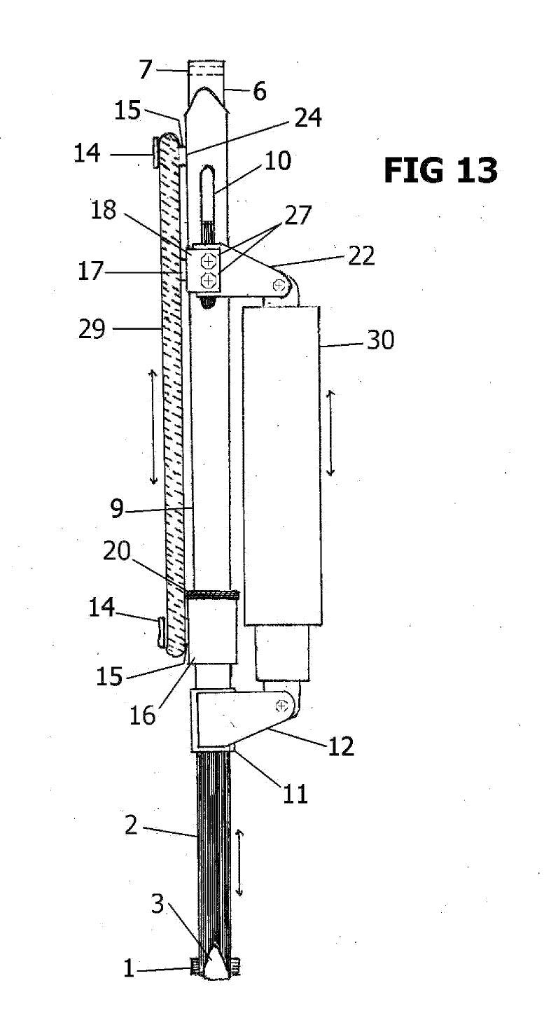

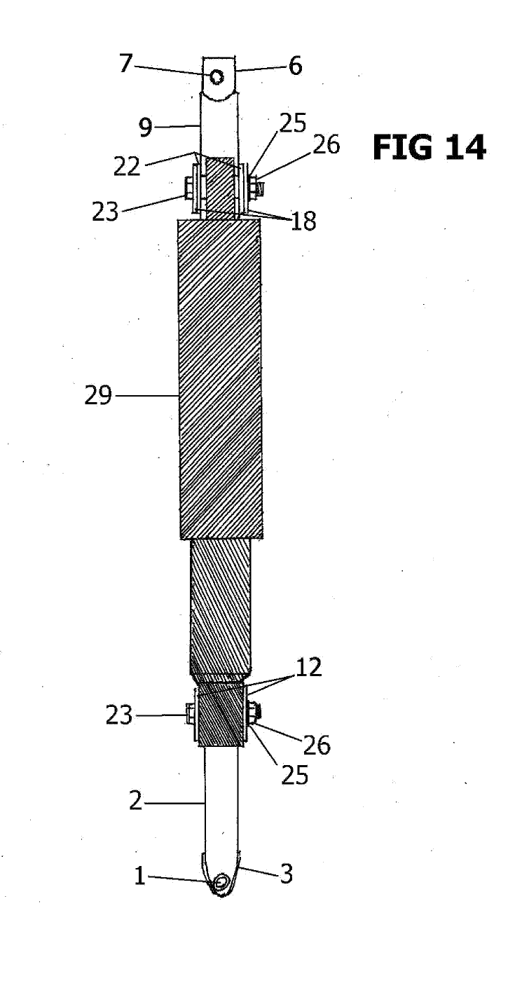

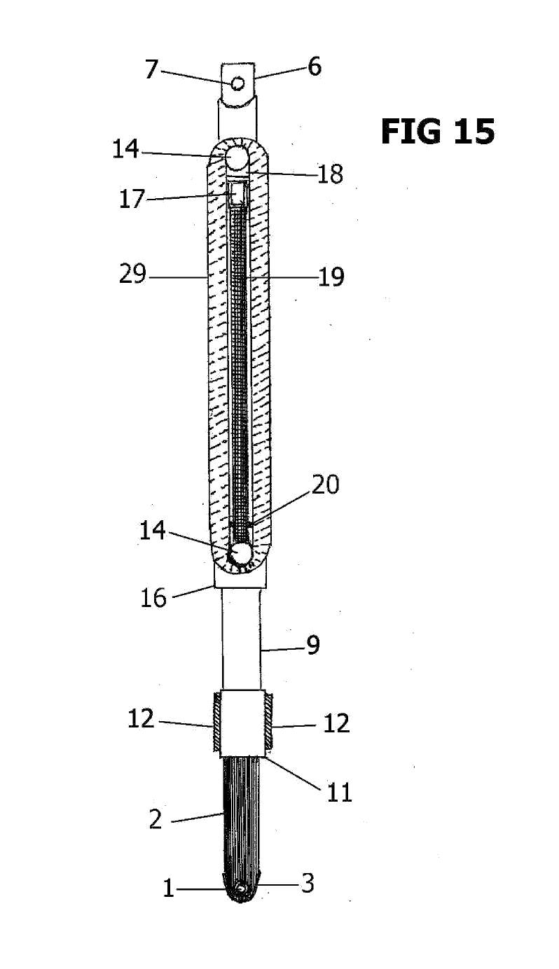

The following references FIGS. 11, 12, 13, 14, and 15. FIG. 11 shows the returns assist spring (29) and shock absorber (30). The upper end of the shock absorber with the larger outside bell is bolted to the dynamic shock mount brackets while the lower end is bolted to the static brackets. The bungee spring assist is then installed over the static and dynamic bungee hooks. The return assist spring also serves to compensate for eccentric loading of the shock strut static and dynamic tubes. FIG. 12 is of the entire shock strut system sitting idle or uncompressed. This is the attitude during flight and while static or parked. FIG. 13 shows the system under compression. The dynamic strut slides outwards with the movements of the landing gear and axle when landing or upon impact. This compresses the shock absorber while stretching the bungee return spring assist. The shock absorber dissipates the kinetic energy then returns at a predictable and adjustable rate. The shock absorber can be adjusted to compensate for the static weight of the aircraft either on the ground or remotely from the cockpit during flight. FIGS. 14 and 15 show the side views of the shock absorber and return assist spring.

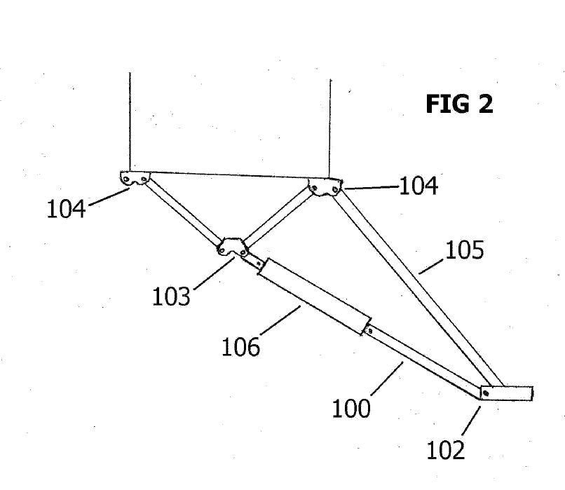

In reference to FIGS. 1, 2, and 12, the strut assembly replaces the bungee strut and the compacted discs respectively. The static tube of the strut is connected to the cabane “v” (FIG. 1, 103) via the cabane “v” attachment (FIG. 12, 7). The dynamic tube of the strut is connected to the axle (FIG. 1, 102) via the axle connection bushing (FIG. 12, 1).

I claim:

1) An airplane landing gear suspension comprising:
a) A static or fixed strut
b) A dynamic or sliding strut
c) A cabane “v” attachment means as a fixed part of the static strut
d) An axle connection as a fixed part of the dynamic strut
e) A bungee hook or retainer fixed to the static strut as a means of connecting a return assist spring
f) A bungee hook or retainer fixed to the dynamic strut as a means of connecting a return assist spring
g) A return assist spring connected to the static and dynamic struts via bungee hooks or retainers
h) A bracket fixed to the static strut as a means of mounting or connecting a shock absorber
i) A bracket fixed to the dynamic strut as a means of mounting or connecting a shock absorber
j) A pushrod and guide sleeve to operate the return assist spring
k) A shock absorber connected to the static and dynamic struts via brackets

2) An airplane landing gear suspension of claim 1 where a static strut incorporates:
a) A slot or hole to allow a connection from the inner dynamic strut to a mounting bracket or connection fitting for a shock absorber and return assist spring.
b) A attachment means to connect to the cabane “v”
c) A mounting bracket to connect the lower end of a shock absorber
d) A bungee hook to retain a return assist spring

3) An airplane landing gear suspension of claim 1 where the dynamic strut incorporates:
a) A attachment means for connecting to the axle
b) A means for connecting to a shock absorber via a connected set of brackets
c) A means for connecting to the return spring and bungee hook or retainer via a connected set of brackets

4) A pushrod and guide sleeve of claim 1 connected to the dynamic strut that:
a) Incorporates a guide sleeve that incorporates the static strut as a fixed guide
b) Has a fixed means of attachment to retain the return assist spring
c) Retains the dynamic strut within the static strut in concert with the mounting bracket and shock absorber mounting brackets
d) Incorporates a pushrod to transfer the kinetic energy imparted by the extension or telescoping of the suspension strut from the dynamic rod to expand the return assist spring

5) A return assist spring of claim 1 mounted opposite of a shock absorber and fixed at one point to the static strut and via a pushrod and guide sleeve to the dynamic strut to:
a) Assist the shock absorber in recovering or returning to a base or static position
b) Compensate for eccentric loading of the static and dynamic struts

6) Incorporates a shock absorber of claim 1 that:
a) Is connected to the static strut via a fixed bracket
b) Is connected to the dynamic strut via a bracket connected through a slot or hole in the static strut
c) Is mounted opposite the return assist spring to compensate for eccentric loading
d) Has an adjustable dampening rate
e) Has an adjustable recovery rate
f) Incorporates an external valve to incorporate or release air to adjust internal shock pressure

7) A static and dynamic strut of claim 1 working in concert that allows:
a) The dynamic strut to telescope or slide when the landing gear is under tensile load
b) The dynamic strut to return to its original state when not under tensile load
c) The dynamic strut to compress a shock absorber via a connecting bracket to dissipate the kinetic energy imparted from the telescoping action of the dynamic strut under tensile load
d) The dynamic strut to expand the return assist spring when telescoping under tensile load
